(19) United States
(12) Patent Application Publication
(10) Pub. No.: US 2005/0069814 A1
(43) Pub. Date: Mar. 31, 2005

(54) Pattern formation method

(75) Inventors: Masayuki Endo, Osaka (JP); Masaru Sasago, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/859,121

(22) Filed: Jun. 3, 2004

(30) Foreign Application Priority Data
Sep. 30, 2003 (JP) 2003-341343

(51) Int. Cl. G03C 5/00

(52) U.S. Cl. 430/311

(57) ABSTRACT

A resist film is formed on a substrate, and pattern exposure is performed by selectively irradiating the resist film with exposing light. A first resist pattern is formed by developing the resist film after the pattern exposure, and subsequently, a water-soluble film including a crosslinking agent that crosslinks a material of the resist and an acid, that is, a crosslinkage accelerator for accelerating a crosslinking reaction of the crosslinking agent, is formed over the substrate including the first resist pattern. Thereafter, a crosslinking reaction is caused by annealing between a portion of the water-soluble film and a portion of the first resist pattern in contact with each other on the sidewall of the first resist pattern, and then, a portion of the water-soluble film not reacted with the first resist pattern is removed. Thus, a second resist pattern made of the first resist pattern and the water-soluble film remaining on the sidewall of the first resist pattern is formed.

### BACKGROUND OF THE INVENTION

The present invention relates to a pattern formation method for use in fabrication process or the like for semiconductor devices.

Recently, in the fabrication process for semiconductor devices, the resolution of a resist pattern obtained by lithography has been further refined in accordance with increase of the degree of integration of semiconductor devices. In particular, in a resist pattern having an opening (a hole) for forming a contact hole, the contrast is lowered when the conventional photolithography is employed, and hence, it has become difficult to obtain a desired shape.

Therefore, for forming a fine contact hole pattern through the photolithography, a method in which an opening of the contact hole pattern is shrunk by forming a water-soluble film including a crosslinking agent over a resist pattern previously formed and causing a crosslinking reaction between the resist pattern and the water-soluble film with heat used as a catalyst by using an acid remaining in an unexposed portion of the resist pattern has been proposed (see, for example, T. Ishibashi et al., “Advanced Micro-Lithography Process with Chemical Shrink Technology”, Jpn. J. Appl. Phys., Vol. 40, p. 419 (2001)).

Now, a pattern formation method employing the conventional chemical shrink method will be described with reference to FIGS. 9A through 9D and 10A through 10C.

First, a positive chemically amplified resist material having the following composition is prepared:

| | | | |
|---|---|---|---|
| Base polymer: | poly(2-methyl-2-adamantyl acrylate-γ- | 2 | g |
| | butyrolactone methacrylate) | | |
| Acid generator: | triphenylsulfonium nonaflate | 0.06 | g |
| Quencher: | triethanolamine | 0.002 | g |
| Solvent: | propylene glycol monomethyl ether | 20 | g |
| | acetate | | |

Next, as shown in FIG. 9A, the chemically amplified resist material is applied on a substrate 1, so as to form a resist film 2 with a thickness of 0.4 μm.

Then, as shown in FIG. 9B, the resist film 2 is subjected to pattern exposure by irradiating with exposing light 3 by using an ArF excimer laser scanner having numerical aperture (NA) of 0.60 through a mask 4.

After the pattern exposure, as shown in FIG. 9C, the resist film 2 is subjected to post-exposure bake (PEB) at a temperature of 105° C. for 90 seconds.

Next, the resist film 2 is developed with a 2.38 wt % tetramethylammonium hydroxide developer (alkaline developer) for 60 seconds. Thus, as shown in FIG. 9D, an initial resist pattern 2a with a first opening made of an unexposed portion of the resist film 2 is obtained.

Subsequently, as shown in FIG. 10A, a water-soluble film 5 including a crosslinking agent having the following composition is applied over the substrate 1 including the initial resist pattern 2a by spin coating:

| | | | |
|---|---|---|---|
| Base polymer: | poly(vinyl alcohol) | 2 | g |
| Crosslinking agent: | 2,4,6-tris(methoxymethyl)amino-1,3,5-s- | 0.2 | g |
| | triazine | | |
| Solvent: | water | 30 | g |

Then, as shown in FIG. 10B, the water-soluble film 5 is annealed at a temperature of 130° C. for 60 seconds, so as to cause a crosslinking reaction between the sidewall of the opening of the initial resist pattern 2a and a portion of the water-soluble film 5 in contact with the sidewall.

Next, as shown in FIG 10C, a portion of the water-soluble film 5 not reacted with the initial resist pattern 2a is removed by using pure water. In this manner, a resist pattern 7 with a second opening made of the initial resist pattern 2a and a remaining portion 5a of the water-soluble film 5 obtained through the crosslinking reaction with the sidewall of the initial resist pattern 2a can be obtained. Thus, the first opening diameter of the resist pattern 7 is shrunk to be the initial resist pattern 2a having the second opening of which diameter is smaller than the diameter of the first opening diameter.

However, the resist pattern 7 to be used for forming a contact hole obtained by the conventional chemical shrink method disadvantageously tends to be in a poor shape as shown in FIG. 10C. When the resist pattern 7 having the shrunk opening is thus in a poor shape, a pattern of a member to be etched in subsequent etching is also in a poor shape, which causes a serious problem in fabrication of semiconductor devices.

In other words, a pattern of an etching target member obtained by using the resist pattern 7 in a poor shape is also in a poor shape, and therefore, productivity and yield in the fabrication process for semiconductor devices are disadvantageously lowered. Although a positive chemically amplified resist material is used for forming the resist film 2 in the above description, such a pattern failure is caused also when a negative chemically amplified resist material is used.

### SUMMARY OF THE INVENTION

In consideration of the aforementioned conventional disadvantages, an object of the invention is forming a resist pattern in a good shape through a chemical shrink method.

The present inventors have made various examinations to find the cause of the poor shape of a resist pattern obtained by the conventional chemical shrink method, resulting in reaching the following conclusion: The crosslinking reaction of a water-soluble film used for shrinking the opening diameter of an opening pattern is caused, with heat used as a catalyst, owing to an acid remaining on a sidewall of a resist pattern obtained after development corresponding to, for example, an unexposed portion in using a positive resist. However, in the conventional pattern formation method, the amount of the acid remaining on the resist pattern after the development is not sufficient for the crosslinking reaction.

On the basis of this conclusion, it has been found that a crosslinking reaction is sufficiently caused between a water-soluble film and a resist film by adding, to the water-soluble film used for shrinking the opening diameter, a crosslinkage accelerator (such as an acid) for accelerating a crosslinking reaction with a resist material.

The present invention was devised on the basis of this finding and is practiced by the following method:

The pattern formation method of this invention includes the steps of forming a resist film on a substrate; performing pattern exposure by selectively irradiating the resist film with exposing light; forming a first resist pattern by developing the resist film after the pattern exposure; forming, over the substrate including the first resist film, a water-soluble film including a crosslinking agent that crosslinks a material of the first resist pattern and a crosslinkage accelerator for accelerating a reaction of the crosslinking agent; causing a crosslinking reaction, by annealing the water-soluble film, between a portion of the water-soluble film and a portion of the first resist pattern in contact with each other on a sidewall of the first resist pattern; and forming a second resist pattern made of the first resist pattern and the water-soluble film remaining on the sidewall of the first resist pattern by removing a portion of the water-soluble film not reacted with the first resist pattern.

According to the pattern formation method of this invention, in the step of forming the water-soluble film used for shrinking the opening diameter of the first resist pattern, the water-soluble film includes the crosslinkage accelerator for accelerating a crosslinking reaction of the crosslinking agent that crosslinks the material of the first resist pattern. Therefore, a crosslinking reaction is sufficiently caused between the water-soluble film and the material of the first resist pattern (i.e., the resist film) in the subsequently performed annealing, and hence, the second resist pattern made of the first resist pattern and the water-soluble film remaining on the sidewall of the first resist pattern is formed in a good shape.

In this case, the crosslinkage accelerator is preferably an acid, an acidic polymer or an acid generator for generating an acid through annealing. This is because a generally used resist film is mostly made from such a material that an acid remains on the sidewall of a resist pattern after formation, namely, after development, and the crosslinking reaction of the crosslinking agent included in the water-soluble film is caused owing to this remaining acid.

Alternatively, in this case, the crosslinkage accelerator is preferably a water-soluble compound. In general, a water-soluble compound has a comparatively low molecular weight and has a high degree of movement freedom within the water-soluble film before solidification. Therefore, the water-soluble compound stirs the acid remaining on the resist material and the crosslinking agent included in the water-soluble film, so as to improve the reaction probability of the crosslinking reaction between the water-soluble film and the resist film. As a result, a crosslinking reaction can be sufficiently caused between the water-soluble film and the resist film.

In the pattern formation method of this invention, the resist film is preferably made from a chemically amplified resist. This is because a chemically amplified resist releases an acid through exposure as conventionally known and hence is suitable to the chemical shrink method.

### BRIEF DESCRIPTION OF THE DRAWINGS

FIGS. 1A, 1B, 1C and 1D are cross-sectional views for showing the order of procedures in a pattern formation method according to Embodiment 1 of the invention;

FIGS. 2A, 2B and 2C are other cross-sectional views for showing the order of procedures in the pattern formation method according to Embodiment 1 of the invention;

FIGS. 3A, 3B, 3C and 3D are cross-sectional views for showing the order of procedures in a pattern formation method according to Embodiment 2 of the invention;

FIGS. 4A, 4B and 4C are other cross-sectional views for showing the order of procedures in the pattern formation method according to Embodiment 2 of the invention;

FIGS. 5A, 5B, 5C and 5D are cross-sectional views for showing the order of procedures in a pattern formation method according to Embodiment 3 of the invention;

FIGS. 6A, 6B and 6C are other cross-sectional views for showing the order of procedures in the pattern formation method according to Embodiment 3 of the invention;

FIGS. 7A, 7B, 7C and 7D are cross-sectional views for showing the order of procedures in a pattern formation method according to Embodiment 4 of the invention;

FIGS. 8A, 8B and 8C are other cross-sectional views for showing the order of procedures in the pattern formation method according to Embodiment 4 of the invention;

FIGS. 9A, 9B, 9C and 9D are cross-sectional views for showing the order of procedures in a conventional pattern formation method employing a chemical shrink method; and

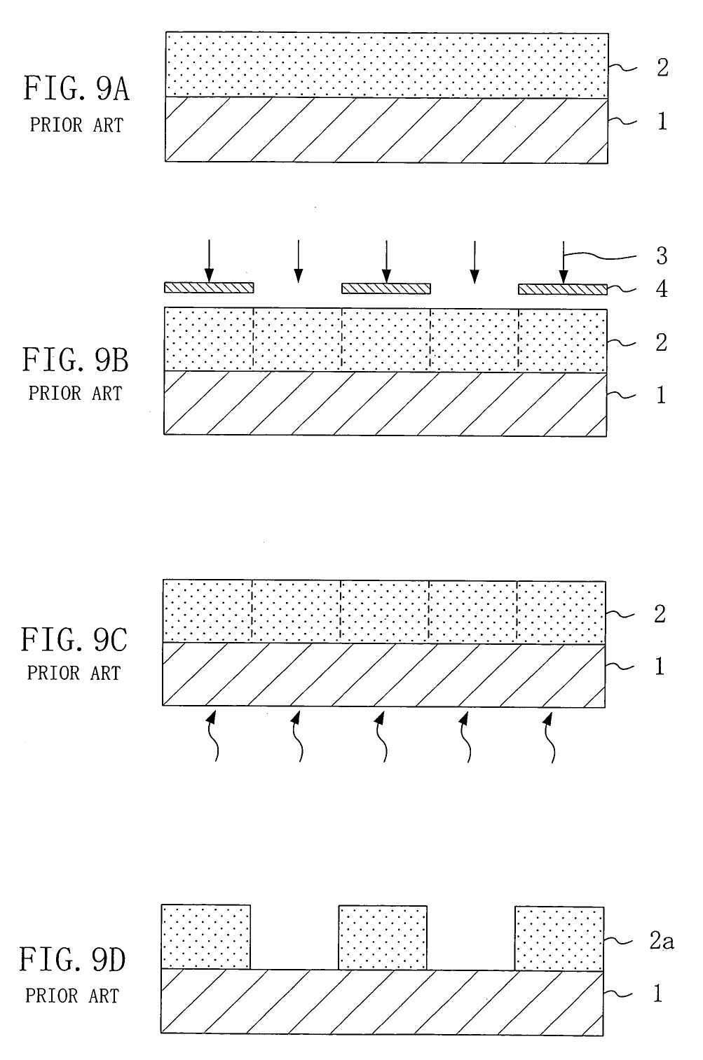

FIGS. 10A, 10B and 10C are other cross-sectional views for showing the order of procedures in the conventional pattern formation method employing the chemical shrink method.

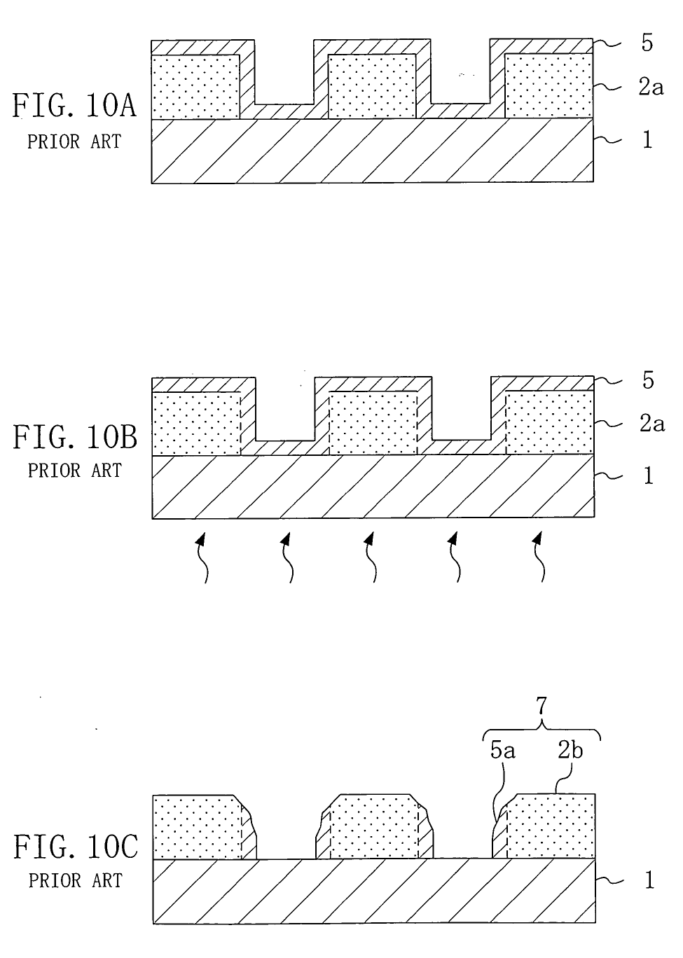

### DETAILED DESCRIPTION OF THE INVENTION

### EMBODIMENT 1

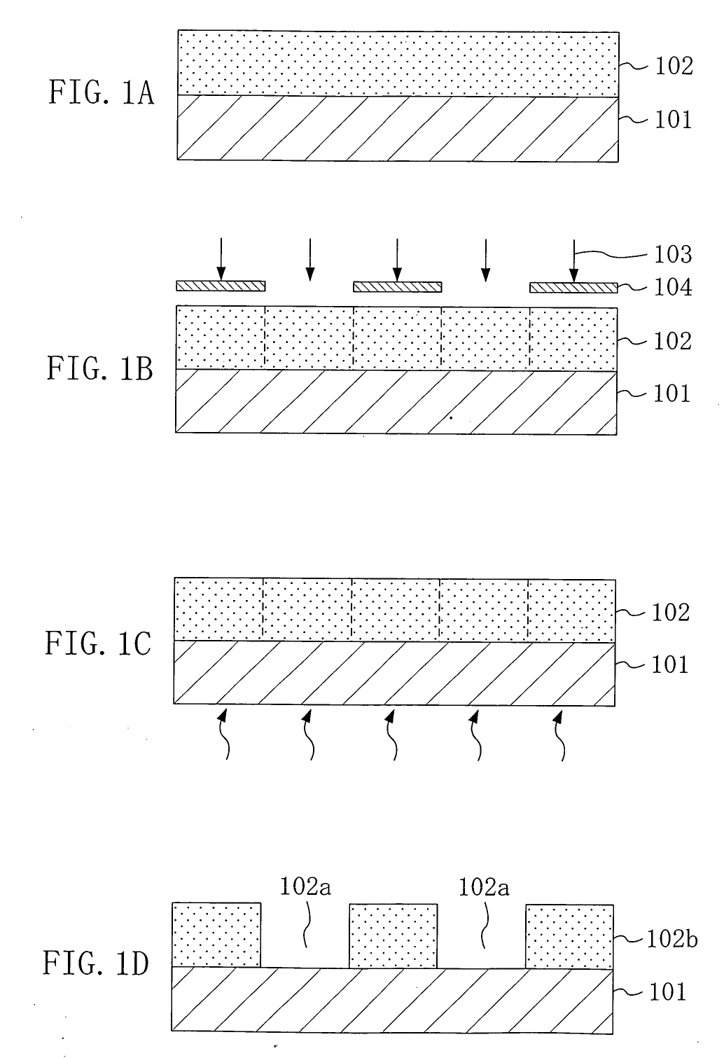

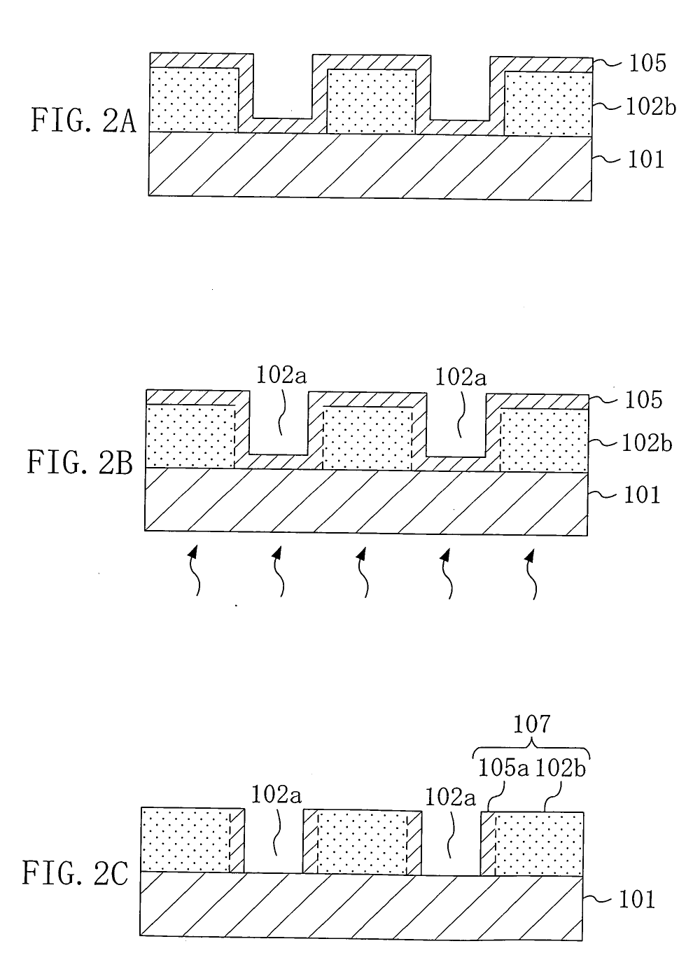

A pattern formation method according to Embodiment 1 of the invention will now be described with reference to FIGS. 1A through 1D and 2A through 2C.

First, a positive chemically amplified resist material having the following composition is prepared:

| | | | |
|---|---|---|---|
| Base polymer: | poly(2-methyl-2-adamantyl acrylate-γ- | 2 | g |
| | butyrolactone methacrylate) | | |
| Acid generator: | triphenylsulfonium nonaflate | 0.06 | g |
| Quencher: | triethanolamine | 0.002 | g |
| Solvent: | propylene glycol monomethyl ether acetate | 20 | g |

Next, as shown in FIG. 1A, the chemically amplified resist material is applied on a substrate 101, so as to form a resist film 102 with a thickness of 0.4 μm.

Then, as shown in FIG. 1B, the resist film 102 is subjected to pattern exposure by irradiating with exposing light 103 by using an ArF excimer laser scanner having numerical aperture (NA) of 0.60 through a mask 104.

After the pattern exposure, as shown in FIG. 1C, the resist film 102 is subjected to post-exposure bake (PEB) by using, for example, a hot plate at a temperature of 105° C. for 90 seconds.

Next, the resist film 102 is developed with a 2.38 wt % tetramethylammonium hydroxide developer (alkaline developer) for 60 seconds. Thus, as shown in FIG 1D, a first resist pattern 102b that is to be used for, for example, forming a contact hole, has an opening 102a with a diameter of 0.20 μm and is made of an unexposed portion of the resist film 102 is obtained.

Subsequently, as shown in FIG. 2A, a water-soluble film 105 including a crosslinking agent and an acid, that is, a crosslinkage accelerator for accelerating a reaction of the crosslinking agent, having the following composition is applied over the substrate 101 including the first resist pattern 102b by, for example, spin coating:

| | | | |
|---|---|---|---|
| Base polymer: | poly(vinyl alcohol) | 2 | g |
| Crosslinking agent: | 2,4,6-tris(methoxymethyl) | 0.2 | g |
| | amino-1,3,5-s-triazine | | |
| Acid: | acetic acid | 0.06 | g |
| Solvent: | water | 30 | g |

Then, as shown in FIG. 2B, the water-soluble film 105 is annealed at a temperature of 130° C. for 60 seconds, so as to cause a crosslinking reaction between a sidewall of the opening 102a of the first resist pattern 102b and a portion of the water-soluble film 105 in contact with the sidewall. At this point, the water-soluble film 105 reacts merely with the sidewall of the opening 102a of the first resist pattern 102b because the top face of the first resist pattern 102b corresponds to the unexposed portion that has not been irradiated with the exposing light 103 and hence no acid generated from the resist film 102 remains on the top face.

Furthermore, although the content of the acetic acid in the water-soluble film 105 is 0.2 wt % with respect to the water used as the solvent in this embodiment, the content may be increased to approximately several wt %. It is noted that the acetic acid may be included to an extent that the water-soluble film 105 itself is not solidified through the annealing performed for causing the crosslinking reaction.

Next, as shown in FIG. 2C, a portion of the water-soluble film 105 not reacted with the first resist pattern 102b is removed by using pure water. In this manner, a second resist pattern 107 with a shrunk opening diameter of 0.15 μm made of the first resist pattern 102b and a sidewall covering portion 105a of the water-soluble film 105 formed on the sidewall of the opening 102a of the first resist pattern 102b can be obtained in a good shape.

Thus, according to Embodiment 1, the water-soluble film 105 used for shrinking the opening diameter of the opening 102a of the first resist pattern 102b includes the acetic acid for replenishing the acid remaining on the sidewall of the opening 102a. Therefore, the crosslinking agent included in the water-soluble film 105 sufficiently reacts in the annealing for causing the crosslinking reaction, and hence, the sidewall covering portion 105a of the water-soluble film 105 can be definitely formed. As a result, the second resist pattern 107 can be formed in a good shape.

The acid included in the water-soluble film 105 may be hydrochloric acid, trifluoromethanesulfonic acid or nonafluorobutanesulfonic acid instead of acetic acid.

Furthermore, the pure water used for removing the water-soluble film 105 may include a surfactant.

### EMBODIMENT 2

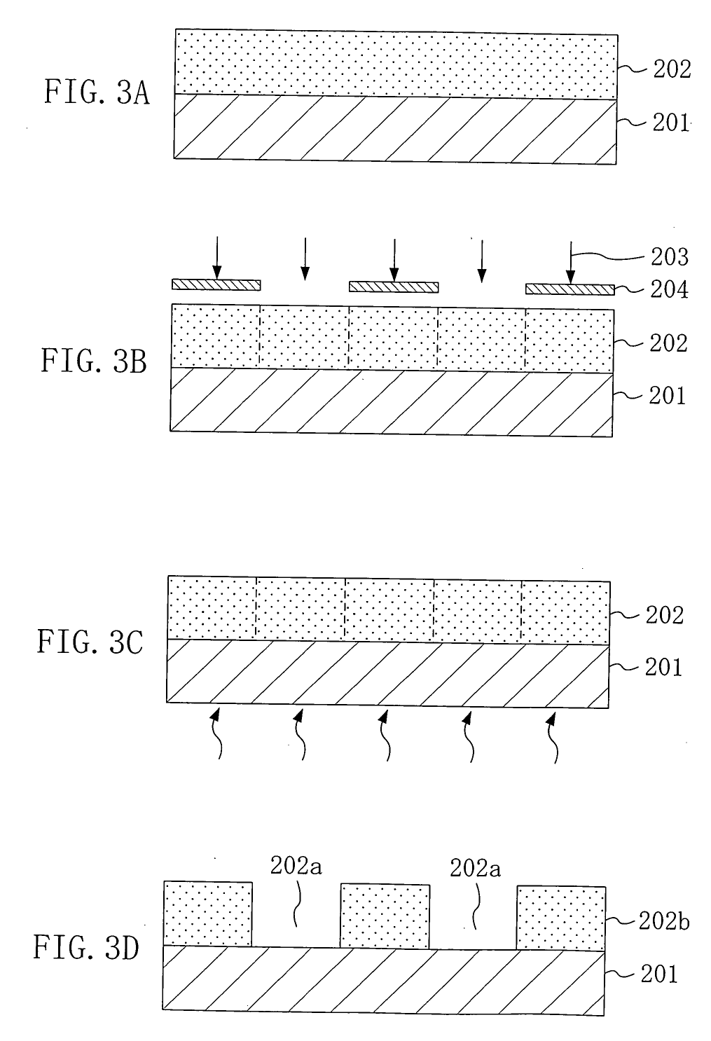

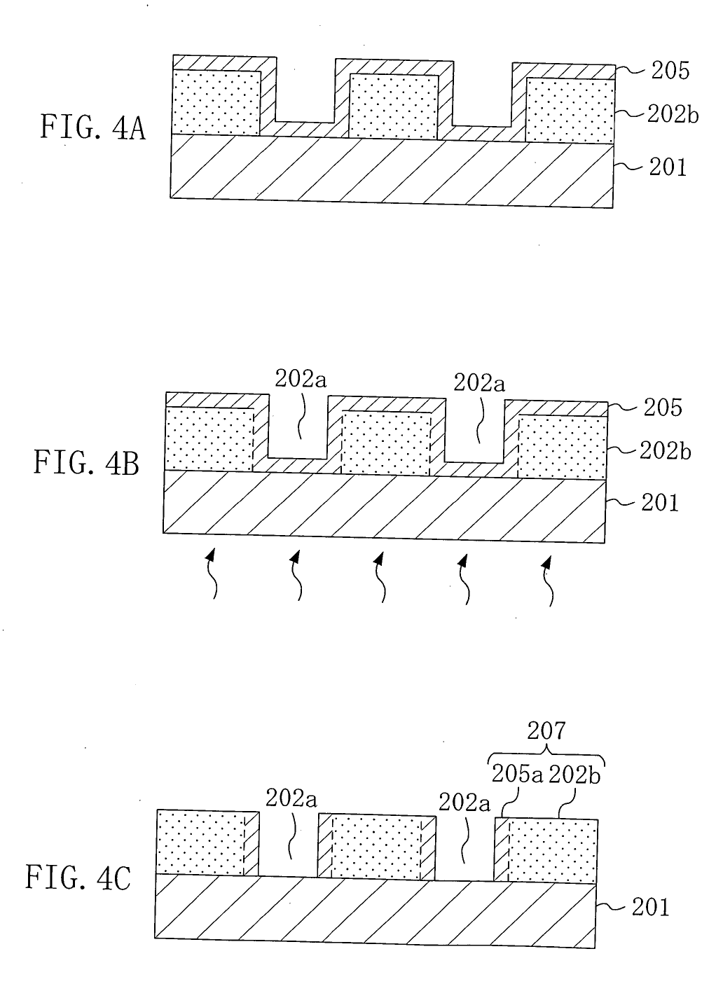

A pattern formation method according to Embodiment 2 of the invention will now be described with reference to FIGS. 3A through 3D and 4A through 4C.

First, a positive chemically amplified resist material having the following composition is prepared:

| | | | |
|---|---|---|---|
| Base polymer: | poly(2-methyl-2-adamantyl acrylate-γ- | 2 | g |
| | butyrolactone methacrylate) | | |
| Acid generator: | triphenylsulfonium nonaflate | 0.06 | g |
| Quencher: | triethanolamine | 0.002 | g |
| Solvent: | propylene glycol monomethyl ether acetate | 20 | g |

Next, as shown in FIG. 3A, the chemically amplified resist material is applied on a substrate 201, so as to form a resist film 202 with a thickness of 0.4 μm.

Then, as shown in FIG. 3B, the resist film 202 is subjected to the pattern exposure by irradiating with exposing light 203 by using an ArF excimer laser scanner having numerical aperture (NA) of 0.60 through a mask 204.

After the pattern exposure, as shown in FIG. 3C, the resist film 202 is subjected to the post-exposure bake (PEB) by using, for example, a hot plate at a temperature of 105° C. for 90 seconds.

Next, the resist film 202 is developed with a 2.38 wt % tetramethylammonium hydroxide developer (alkaline developer) for 60 seconds. Thus, as shown in FIG. 3D, a first resist pattern 202b that is to be used for, for example, forming a contact hole, has an opening 202a with a diameter of 0.20 μm and is made of an unexposed portion of the resist film 202 is obtained.

Subsequently, as shown in FIG. 4A, a water-soluble film 205 including a crosslinking agent and an acidic polymer, that is, a crosslinkage accelerator for accelerating a reaction of the crosslinking agent, having the following composition is applied over the substrate 201 including the first resist pattern 202b by, for example, spin coating:

| | | | |
|---|---|---|---|
| Base polymer: | poly(vinyl alcohol) | 2 | g |
| Crosslinking agent: | 2,4,6-tris(methoxymethyl) | 0.2 | g |
| | amino-1,3,5-s-triazine | | |
| Acidic polymer: | polyacrylic acid | 0.05 | g |
| Solvent: | water | 30 | g |

Then, as shown in FIG. 4B, the water-soluble film 205 is annealed at a temperature of 130° C. for 60 seconds, so as to cause a crosslinking reaction between a sidewall of the opening 202a of the first resist pattern 202b and a portion of the water-soluble film 205 in contact with the sidewall. At this point, the water-soluble film 205 reacts merely with the sidewall of the opening 202a of the first resist pattern 202b because the top face of the first resist pattern 202b corresponds to the unexposed portion that has not been irradiated with the exposing light 203 and hence no acid generated from the resist film 202 remains on the top face.

Furthermore, although the content of the polyacrylic acid in the water-soluble film 205 is approximately 0.17 wt % with respect to the water used as the solvent in this embodiment, the content may be increased to approximately several wt %. It is noted that the polyacrylic acid may be included to an extent that the water-soluble film 205 itself is not solidified through the annealing performed for causing the crosslinking reaction.

Next, as shown in FIG. 4C, a portion of the water-soluble film 205 not reacted with the first resist pattern 202b is removed by using pure water. In this manner, a second resist pattern 207 with a shrunk opening diameter of 0.15 μm made of the first resist pattern 202b and a sidewall covering portion 205a of the water-soluble film 205 formed on the sidewall of the opening 202a of the first resist pattern 202b can be obtained in a good shape.

Thus, according to Embodiment 2, the water-soluble film 205 used for shrinking the opening diameter of the opening 202a of the first resist pattern 202b includes the polyacrylic acid for replenishing the acid remaining on the sidewall of the opening 202a. Therefore, the crosslinking agent included in the water-soluble film 205 sufficiently reacts in the annealing for causing the crosslinking reaction, and hence, the sidewall covering portion 205a of the water-soluble film 205 can be definitely formed. As a result, the second resist pattern 207 can be formed in a good shape.

The acidic polymer included in the water-soluble film 205 may be polystyrene sulfonic acid instead of polyacrylic acid.

Furthermore, the pure water used for removing the water-soluble film 205 may include a surfactant.

### EMBODIMENT 3

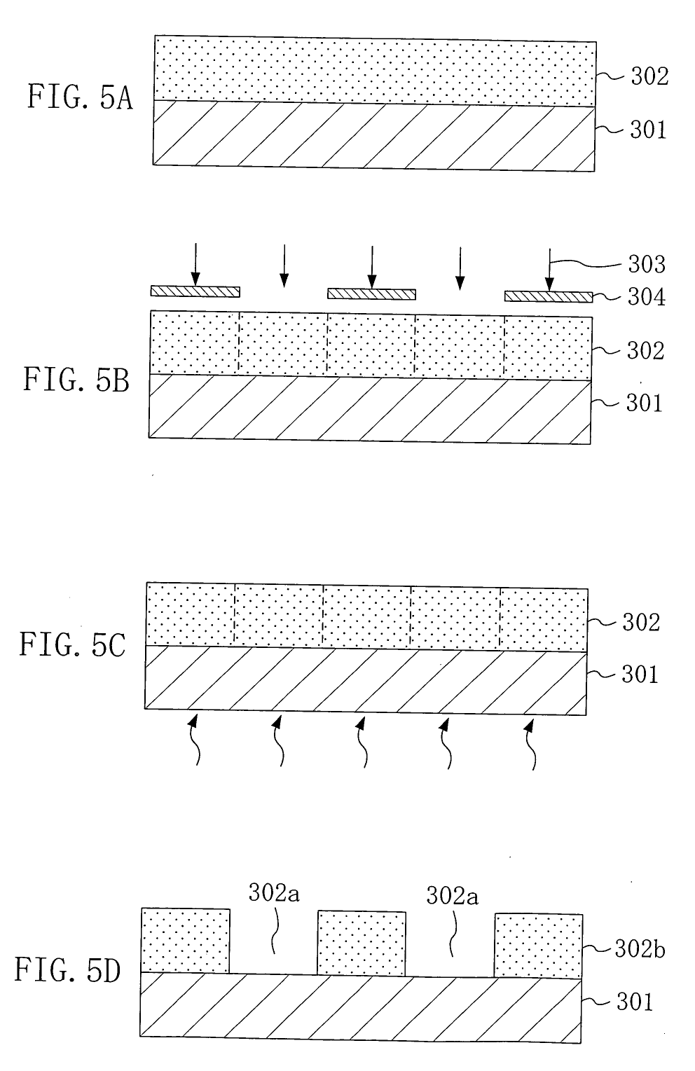

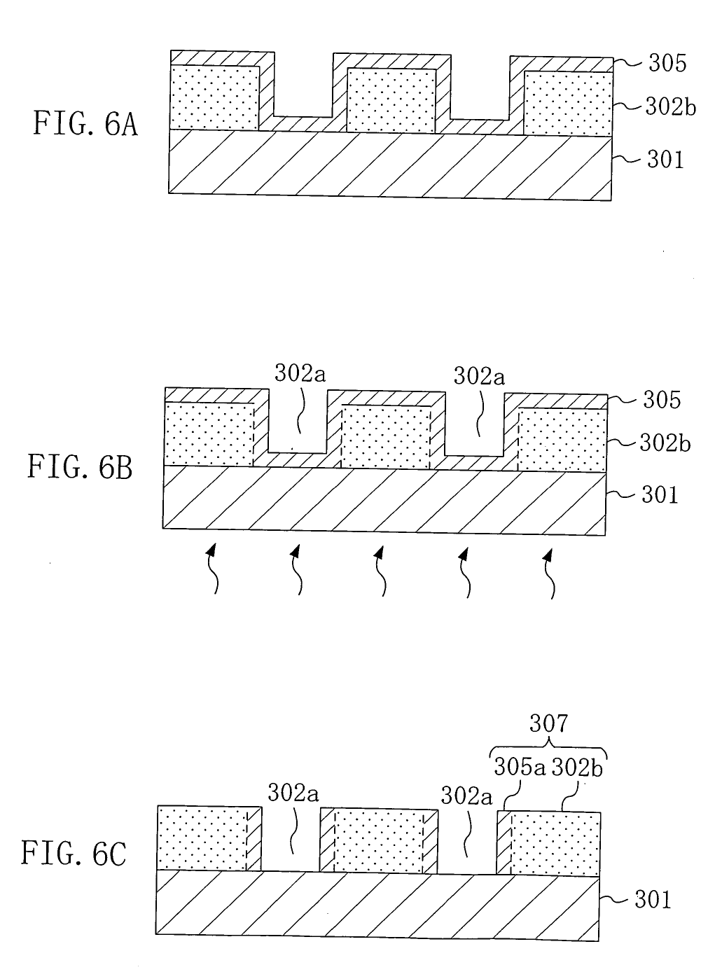

A pattern formation method according to Embodiment 3 of the invention will now be described with reference to FIGS. 5A through 5D and 6A through 6C.

First, a positive chemically amplified resist material having the following composition is prepared:

| | | | |
|---|---|---|---|
| Base polymer: | poly(2-methyl-2-adamantyl acrylate-γ- | 2 | g |
| | butyrolactone methacrylate) | | |
| Acid generator: | triphenylsulfonium nonaflate | 0.06 | g |
| Quencher: | triethanolamine | 0.002 | g |
| Solvent: | propylene glycol monomethyl ether acetate | 20 | g |

Next, as shown in FIG. 5A, the chemically amplified resist material is applied on a substrate 301, so as to form a resist film 302 with a thickness of 0.4 μm.

Then, as shown in FIG. 5B, the resist film 302 is subjected to the pattern exposure by irradiating with exposing light 303 by using an ArF excimer laser scanner having numerical aperture (NA) of 0.60 through a mask 304.

After the pattern exposure, as shown in FIG. 5C, the resist film 302 is subjected to the post-exposure bake (PEB) by using, for example, a hot plate at a temperature of 105° C. for 90 seconds.

Next, the resist film 302 is developed with a 2.38 wt % tetramethylammonium hydroxide developer (alkaline developer) for 60 seconds. Thus, as shown in FIG. 5D, a first resist pattern 302b that is to be used for, for example, forming a contact hole, has an opening 302a with a diameter of 0.20 μm and is made of an unexposed portion of the resist film 302 is obtained.

Subsequently, as shown in FIG. 6A, a water-soluble film 305 including a crosslinking agent and an acid generator for generating an acid through annealing, that is, a crosslinkage accelerator for accelerating a reaction of the crosslinking agent, having the following composition is applied over the substrate 301 including the first resist pattern 302b by, for example, spin coating:

| | | | |
|---|---|---|---|
| Base polymer: | poly(vinyl alcohol) | 2 | g |
| Crosslinking agent: | 2,4,6-tris(methoxymethyl) | 0.2 | g |
| | amino-1,3,5-s-triazine | | |
| Acid generator: | perfluorobenzene | 0.04 | g |
| | trifluoromethanesulfonic ester | | |
| Solvent: | water | 30 | g |

Then, as shown in FIG. 6B, the water-soluble film 305 is annealed at a temperature of 130° C. for 60 seconds, so as to cause a crosslinking reaction between a sidewall of the opening 302a of the first resist pattern 302b and a portion of the water-soluble film 305 in contact with the sidewall. At this point, the water-soluble film 305 reacts merely with the sidewall of the opening 302a of the first resist pattern 302b because the top face of the first resist pattern 302b corresponds to the unexposed portion that has not been irradiated with the exposing light 303 and hence no acid generated from the resist film 302 remains on the top face.

Furthermore, although the content of the acid generator in the water-soluble film 305 is approximately 0.13 wt % with respect to the water used as the solvent in this embodiment, the content may be increased to approximately several wt %. It is noted that the acid generator may be included to an extent that the water-soluble film 305 itself is not solidified through the annealing performed for causing the crosslinking reaction.

Next, as shown in FIG. 6C, a portion of the water-soluble film 305 not reacted with the first resist pattern 302b is removed by using pure water. In this manner, a second resist pattern 307 with a shrunk opening diameter of 0.15 μm made of the first resist pattern 302b and a sidewall covering portion 305a of the water-soluble film 305 formed on the sidewall of the opening 302a of the first resist pattern 302b can be obtained in a good shape.

Thus, according to Embodiment 3, the water-soluble film 305 used for shrinking the opening diameter of the opening 302a of the first resist pattern 302b includes the acid generator for generating an acid through annealing for replenishing the acid remaining on the sidewall of the opening 302a. Therefore, the crosslinking agent included in the water-soluble film 305 sufficiently reacts in the annealing for causing the crosslinking reaction, and hence, the sidewall covering portion 305a of the water-soluble film 305 can be definitely formed. As a result, the second resist pattern 307 can be formed in a good shape.

The acid generator for generating an acid through annealing included in the water-soluble film 305 may be, for example, another aromatic sulfonic ester instead of perfluorobenzene trifluoromethanesulfonic ester.

Examples of the aromatic sulfonic ester are 4-fluorobenzene trifluoromethanesulfonic ester, 2,3,4-trifluorobenzene trifluoromethanesulfonic ester, benzene trifluoromethanesulfonic ester, perfluorobenzene nonafluorobutanesulfonic ester, 4-fluorobenzene nonafluorobutanesulfonic ester, 2,3,4-trifluorobenzene nonafluorobutanesulfonic ester and benzene nonafluorobutanesulfonic ester.

Furthermore, the pure water used for removing the water-soluble film 305 may include a surfactant.

### EMBODIMENT 4

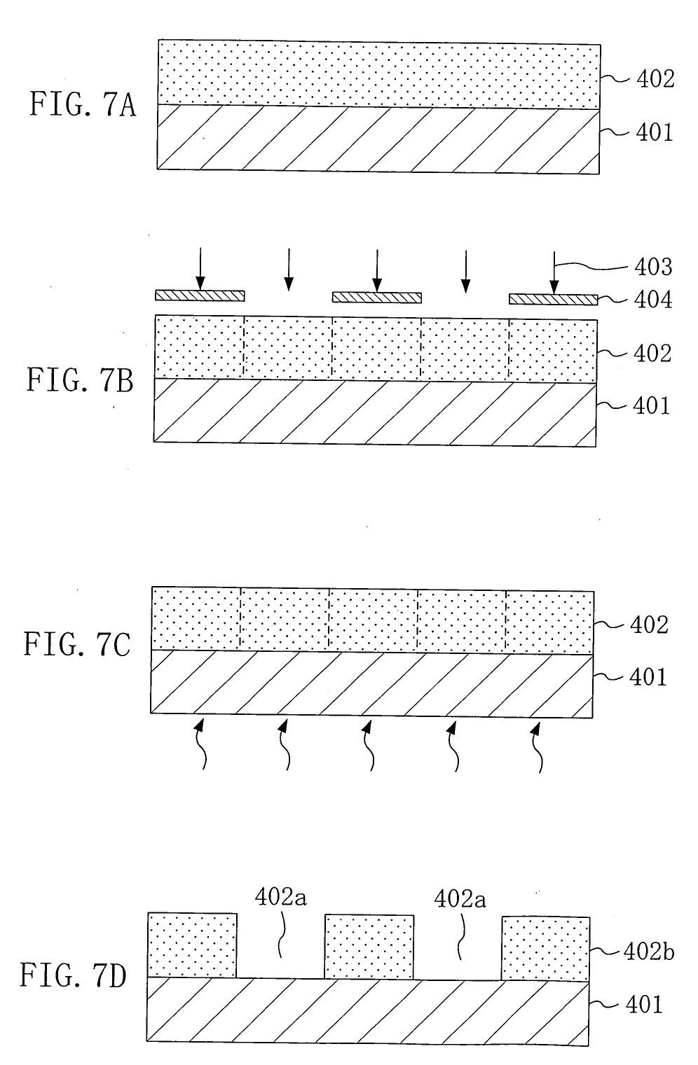

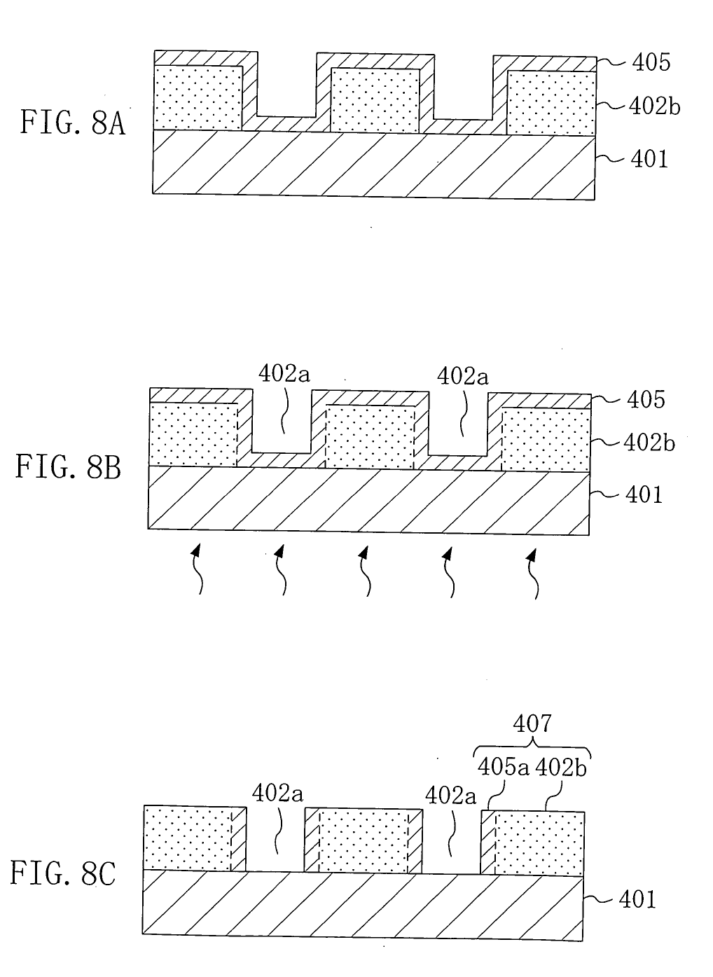

A pattern formation method according to Embodiment 4 of the invention will now be described with reference to FIGS. 7A through 7D and 8A through 8C.

First, a positive chemically amplified resist material having the following composition is prepared:

| | | | |
|---|---|---|---|
| Base polymer: | poly(2-methyl-2-adamantyl acrylate-γ- | 2 | g |
| | butyrolactone methacrylate) | | |
| Acid generator: | triphenylsulfonium nonaflate | 0.06 | g |
| Quencher: | triethanolamine | 0.002 | g |
| Solvent: | propylene glycol monomethyl ether | 20 | g |
| | acetate | | |

Next, as shown in FIG. 7A, the chemically amplified resist material is applied on a substrate 401, so as to form a resist film 402 with a thickness of 0.4 μm.

Then, as shown in FIG. 7B, the resist film 402 is subjected to the pattern exposure by irradiating with exposing light 403 by using an ArF excimer laser scanner having numerical aperture (NA) of 0.60 through a mask 404.

After the pattern exposure, as shown in FIG. 7C, the resist film 402 is subjected to the post-exposure bake (PEB) by using, for example, a hot plate at a temperature of 105° C. for 90 seconds.

Next, the resist film 402 is developed with a 2.38 wt % tetramethylammonium hydroxide developer (alkaline developer) for 60 seconds. Thus, as shown in FIG. 7D, a first resist pattern 402b that is to be used for, for example, forming a contact hole, has an opening 402a with a diameter of 0.20 μm and is made of an unexposed portion of the resist film 402 is obtained.

Subsequently, as shown in FIG. 8A, a water-soluble film 405 including a crosslinking agent and a water-soluble compound, that is, a crosslinkage accelerator for accelerating a reaction of the crosslinking agent, having the following composition is applied over the substrate 401 including the first resist pattern 402b by, for example, spin coating:

| | | | |
|---|---|---|---|
| Base polymer: | poly(vinyl alcohol) | 2 | g |
| Crosslinking agent: | 2,4,6-tris(methoxymethyl) | 0.2 | g |
| | amino-1,3,5-s-triazine | | |
| Water-soluble compound: | bisphenol A | 0.03 | g |
| Solvent: | water | 30 | g |

Then, as shown in FIG. 8B, the water-soluble film 405 is annealed at a temperature of 130° C. for 60 seconds, so as to cause a crosslinking reaction between a sidewall of the opening 402a of the first resist pattern 402b and a portion of the water-soluble film 405 in contact with the sidewall. At this point, the water-soluble film 405 reacts merely with the sidewall of the opening 402a of the first resist pattern 402b because the top face of the first resist pattern 402b corresponds to the unexposed portion that has not been irradiated with the exposing light 403 and hence no acid generated from the resist film 402 remains on the top face.

Furthermore, although the content of the water-soluble compound in the water-soluble film 405 is 0.1 wt % with respect to the water used as the solvent in this embodiment, the content may be increased to approximately several wt %.

Next, as shown in FIG. 8C, a portion of the water-soluble film 405 not reacted with the first resist pattern 402b is removed by using pure water. In this manner, a second resist pattern 407 with a shrunk opening diameter of 0.15 μm made of the first resist pattern 402b and a sidewall covering portion 405a of the water-soluble film 405 formed on the sidewall of the opening 402a of the first resist pattern 402b can be obtained in a good shape.

Thus, according to Embodiment 4, the water-soluble film 405 used for shrinking the opening diameter of the opening 402a of the first resist pattern 402b includes the water-soluble compound that has, before solidification, a high degree of movement freedom because of its low molecular property, and hence, the reaction probability between the acid remaining on the sidewall of the opening 402 and the crosslinking agent included in the water-soluble film 405 is improved. Therefore, the crosslinking agent included in the water-soluble film 405 sufficiently reacts in the annealing for causing the crosslinking reaction, and hence, the sidewall covering portion 405a of the water-soluble film 405 can be definitely formed. As a result, the second resist pattern 407 can be formed in a good shape.

The water-soluble compound included in the water-soluble film 405 may be phenol instead of bisphenol A.

Furthermore, the pure water used for removing the water-soluble film 105 may include a surfactant.

In each of Embodiments 1 through 4, the positive chemically amplified resist material is used as a resist material for forming the first resist pattern. However, the resist material for forming the first resist pattern is not limited to a chemically amplified resist material as far as it is a resist material for generating an acid on the sidewall of the opening after forming the first resist pattern. Also, it is not limited to a positive resist material but may be a negative resist material.

In each of Embodiments 1 through 4, the crosslinking agent included in the water-soluble film used for shrinking the opening diameter of the opening of the first resist pattern is 2,4,6-tris(methoxymethyl)amino-1,3,5-s-triazine. Instead, 1,3,5-N-(trihydroxymethyl)melamine, 2,4,6-tris(ethoxymethyl)amino-1,3,5,-s-triazine, tetramethoxymethyl glyocolurea, tetramethoxymethylurea, 1,3,5-tris(methoxymethoxy)benzene or 1,3,5-tris(isopropoxymethoxy)benzene may be used.

Furthermore, as the base polymer for the water-soluble film, poly(vinylpyrrolidone) may be used instead of poly(vinyl alcohol).

Moreover, in each of Embodiments 1 through 4, the exposing light used for forming the first resist pattern is not limited to ArF excimer layer but KrF excimer layer, F₂ laser, Xe₂ laser, Kr₂ laser, ArKr laser or Ar₂ layer may be appropriately used.

As described so far, the pattern formation method of this invention has an effect to form a resist pattern in a good shape by employing the chemical shrink method, and is useful as a pattern formation method for use in fabrication process or the like for semiconductor devices.

1. A pattern formation method comprising the steps of:
forming a resist film on a substrate;
performing pattern exposure by selectively irradiating said resist film with exposing light;
forming a first resist pattern by developing said resist film after the pattern exposure;
forming, over said substrate having said first resist film, a water-soluble film including a crosslinking agent that crosslinks a material of said first resist pattern and a crosslinkage accelerator for accelerating a reaction of said crosslinking agent;
causing a crosslinking reaction, by annealing said water-soluble film, between a portion of said water-soluble film and a portion of said first resist pattern in contact with each other on a sidewall of said first resist pattern; and
forming a second resist pattern made of said first resist pattern and the portion of said water-soluble film remaining on the sidewall of said first resist pattern by removing a portion of said water-soluble film not reacted with said first resist pattern.

2. The pattern formation method of claim 1,
wherein said crosslinkage accelerator is an acid, an acidic polymer, an acid generator for generating an acid through annealing, or a water-soluble compound.

3. The pattern formation method of claim 1,
wherein said resist film is made from a chemically amplified resist.

4. The pattern formation method of claim 1,
wherein said crosslinking agent is 1,3,5-N-(trihydroxymethyl)melamine, 2,4,6-tris(methoxymethyl)amino-1,3,5-s-triazine, 2,4,6-tris(ethoxymethyl)amino-1,3,5,-s-triazine, tetramethoxymethyl glyocolurea, tetramethoxymethylurea, 1,3,5-tris(methoxymethoxy)benzene or 1,3,5-tris(isopropoxymethoxy)benzene.

5. The pattern formation method of claim 1,
wherein said water-soluble film includes poly(vinyl alcohol) or poly(vinylpyrrolidone).

6. The pattern formation method of claim 2,
wherein said acid is acetic acid, hydrochloric acid, trifluoromethanesulfonic acid or nonafluorobutanesulfonic acid.

7. The pattern formation method of claim 2,
wherein said acidic polymer is polyacrylic acid or polystyrene sulfonic acid.

8. The pattern formation method of claim 2,
wherein said acid generator is an aromatic sulfonic ester.

9. The pattern formation method of claim 8,
wherein said aromatic sulfonic ester is perfluorobenzene trifluoromethanesulfonic ester, 4-fluorobenzene trifluoromethanesulfonic ester, 2,3,4-trifluorobenzene trifluoromethanesulfonic ester, benzene trifluoromethanesulfonic ester, perfluorobenzene nonafluorobutanesulfonic ester, 4-fluorobenzene nonafluorobutanesulfonic ester, 2,3,4-trifluorobenzene nonafluorobutanesulfonic ester or benzene nonafluorobutanesulfonic ester.

10. The pattern formation method of claim 2,
wherein said water-soluble compound is phenol or bisphenol A.

11. A pattern forming method comprising the steps of:
forming a resist film on a substrate;
performing pattern exposure by selectively irradiating said resist film with exposing light;
forming a first resist pattern by developing said resist film after the pattern exposure;
forming, over said substrate having said first resist film, a water-soluble film including a crosslinking agent that crosslinks a material of said first resist pattern and a crosslinkage accelerator for accelerating a reaction of said crosslinking agent;
annealing said substrate; and
forming a second resist pattern made of said first resist pattern having a portion of said water-soluble film on a sidewall of said resist pattern.

12. The pattern formation method of claim 11, wherein the annealing said water-soluble film causes a crosslinking reaction between a portion of said water-soluble film and a portion of said first resist pattern in contact with each other.

13. The pattern formation method of claim 11, wherein the portion of said water-soluble film on the sidewall of said first resist pattern is a remaining portion after removing said water-soluble film that has been annealed.

14. The pattern formation method of claim 13, wherein said remaining portion is a portion without crosslinking reaction between said water-soluble film and said first resist pattern.

15. The pattern formation method of claim 11, wherein said crosslinking accelerator is an acid, an acidic polymer, an acidic generator for generating an acid through annealing, or a water-soluble compound.

16. The pattern formation method of claim 1, wherein said exposing light is ArF exicimer laser.

17. The pattern formation method of claim 11, wherein said exposing light is ArF exicimer laser.

18. The pattern formation method of claim 1, wherein said first resist pattern includes a hole pattern having an opening with a diameter of 0.20 μm and said second resist pattern includes a hole pattern having an opening with a diameter of 0.15 μm.

19. The pattern formation method of claim 11, wherein said first resist pattern includes a hole pattern having an opening with a diameter of 0.20 μm and said second resist pattern includes a hole pattern having an opening with a diameter of 0.15. μm.
